(19) United States
(12) Patent Application Publication
(10) Pub. No.: US 2012/0181810 A1
(43) Pub. Date: Jul. 19, 2012

(54) Truck Bedliner Assembly

(76) Inventor: Leonardo E. Alvarino, Oakville (CA)

(21) Appl. No.: 13/008,963

(22) Filed: Jan. 19, 2011

(51) Int. Cl. B62D 33/00

(52) U.S. Cl. 296/39.2; 296/37.6

(57) ABSTRACT

A bedliner assembly shaped and adapted to be fitted within a pick-up truck hopper in intimate engagement, the bedliner assembly comprising a pair of opposing rectangular planar vertical sides 16,18 spaced one from the other, one side 16 having a first side portion 20 and the other side 18 having an opposing second side portion 22; a rectangular forward panel 24 having a forward upper edge 26 and a lower edge 27; a rectangular rear panel 28 retained between the vertical sides 16,18 and having a lower edge 30 hingedly mounted between the vertical sides 16,18 whereby the rear panel 28 is rotatable from a vertical mode to a collapsed mode; and a rectangular lid 32 having a front edge 34 hingedly connected adjacent to the forward upper edge 26 to allow the lid 32 to rotate from (i) a horizontal lid closed mode when engaged with the rear panel 28 when the rear panel is in a vertical mode, to (ii) a vertical mode parallel to the forward panel 24; and a bedliner floor 36. The assembly provides a container that minimizes or maximizes available space of the truck bed when desired.

### FIELD OF THE INVENTION

This invention relates to truck bedliners for pick-up trucks and storage containers associated therewith.

### BACKGROUND OF THE INVENTION

Pick-up trucks are vehicles designed to carry merchandise placed in their hopper, also called bed or box. Since this hopper can be scratched or dented in use it is often protected by use of truck bedliners which are coverings that protect the inner side of the truck bed from damage. Bedliners are generally of two types, namely, the “plastic drop-in” and the “spray on” types. The first type is made from plastics sheets molded according to the inner bed surface and mounted on top of the truck's metal hopper and can be removed at any time. The “spray on” type is made by compounds applied by roller or pressure machines, similar to paint, and forms a permanent cover.

Once the hopper has its liner, it is very common to use a protective method in order to protect the transported merchandise from the weather or from being stolen. The most popular devices used for this purpose are metal or plastic containers, such as boxes, often installed close to the cab. While these containers are strong and restrain small merchandise in place, they have the inconvenience of taking important space of the hopper when that space is required. This inconvenience is increased when pick-ups have large cabs and short beds.

However, there is a need for a truck assembly having both a protective bed liner and a container that minimizes or maximizes available space of the truck bed when desired.

### SUMMARY OF THE INVENTION

Accordingly, the invention provides in one aspect a bedliner assembly shaped and adapted to be fitted within a pick-up truck hopper in intimate engagement, said bedliner assembly comprising

a pair of opposing rectangular planar vertical sides (16,18) spaced one from the other, one side (16) having a first side portion (20) and the other side (18) having an opposing second side portion (22);

a rectangular forward panel (24) having a forward upper edge (26) and a lower edge (27);

a rectangular rear panel (28) retained between said vertical sides (16,18) and having a lower edge (30) hingedly mounted between said vertical sides (16,18) whereby said rear panel (28) is rotatable from a vertical mode to a collapsed mode;

a rectangular lid (32) having a front edge (34) hingedly connected adjacent to said forward upper edge (26) to allow said lid (32) to rotate from (i) a horizontal lid closed mode when engaged with said rear panel (28) when said rear panel (28) is in a vertical mode, to (ii) a vertical mode parallel to said forward panel (24); and

a bedliner floor (36).

In a most preferred embodiment, a bedliner assembly as hereinabove defined has said rear panel (28) releasably retained to said vertical sides (16,18).

In one preferred embodiment, a bedliner assembly as hereinabove defined has said lower edge (30) is hingedly mounted to said floor (36).

In a further preferred embodiment, a bedliner assembly as hereinabove defined comprises a rectangular base panel (38) between said portions (20,22) and having a rear edge (40) hingedly connected to said rear panel (28), lower edge (30), and a front edge (42) hingedly connected adjacent to lower edge (27) of said forward panel (24); whereby said base panel (38) is rotatable from a horizontal floor (36) abutment mode to a vertical mode parallel to said forward panel (24), and said rear panel (28) is rotatable from a vertical mode distal from said forward panel (24) to a vertical mode proximal to said forward panel (24).

In a further preferred embodiment, a bedliner assembly as hereinabove defined has said front edge (42) hingedly connected to said forward panel lower edge (27).

In an alternative preferred embodiment, a bedliner assembly as hereinabove defined has said front edge (42) hingedly connected to said floor (36).

In a further preferred embodiment, rear panel (28) is in a vertical mode and said lid (32) is in a horizontal mode in abutment with said rear panel (28) as to constitute a closed container.

In a further preferred embodiment, said rear panel (28), said lid (32) and said forward panel (24) are in parallel alignment as to constitute a collapsed, folded container.

In a further preferred embodiment, said rear panel (28), said lid (32), said base panel (38) and said forward panel (24) are in parallel alignment as to constitute a collapsed, folded container.

In a further preferred embodiment, said rear panel (28) is in a vertical mode, and said lid (32) and said base panel (38) are in a horizontal parallel alignment as to constitute a closed container.

In a most preferred embodiment, a bedliner assembly as hereinabove defined comprises

(a) a first retractable horizontal plate (46) affixed adjacent to the upper surface (48) of said first portion (20) operably retractable, (i) from an outer position to allow said rotatable movement of said lid (38) to, (ii) an inner position to restrict said rotatable movement of said lid (32); and

(b) a second retractable horizontal plate (50) affixed adjacent to the upper surface (52) of said second portion (22) operably retractable (i) from an outer position to allow said rotatable movement of said lid (32), (ii) to an inner position to restrict said rotatable movement of said lid (32).

In preferred embodiments, each of said retractable plates (46,50) has a longitudinal terminal lip portion (54,56) defining a lower channel (58,60) to receive and retain said lid (32) in a closed mode.

In preferred embodiments, each of said retractable plates (46,50) are retained to an inward flange (62,64) comprising said upper surface (48,52) of said first portion (20) and said second portion (22).

In most preferred embodiments, said inward flanges (62,64) are integrally formed with said first and second side portions (20,22).

### BRIEF DESCRIPTION OF THE DRAWINGS

In order that the invention may be better understood, preferred embodiments will now be described, by way of example only, wherein

FIG. 1 is a diagrammatic perspective view of a bedliner for a pick-up truck, according to the prior art;

FIG. 2 is a diagrammatic perspective view of a pick-up truck to receive the bedliner shown in FIG. 1;

FIGS. 3a, 3b and 3c are diagrammatic perspective views of a bedliner 15, wherein FIG. 3a is seen from an upper rear side, FIG. 3b from an upper front side, and FIG. 3c from a lower underneath front view;

FIGS. 4a-4b are diagrammatic exploded views of an assembly according to the invention having a container in an exploded, unfolded mode;

FIG. 5 is the assembly of FIG. 4 in an unexploded, but partially collapsed mode;

FIG. 6 is a diagrammatic perspective view of the container having an open lid 32 in a bedliner, according to the invention;

FIGS. 7a-7h are diagrammatic perspective views of the steps of collapsing and folding the container of a bedliner assembly, according to the invention;

FIG. 8 shows a retractable plate;

FIG. 9 shows the bedliner assembly with retractable plates;

FIG. 10a-10c shows an exploded view of an open container of an alternative assembly, without a base plate, according to the invention;

and wherein the same numerals denotes like parts.

### DETAILED DESCRIPTION OF PREFERRED EMBODIMENTS

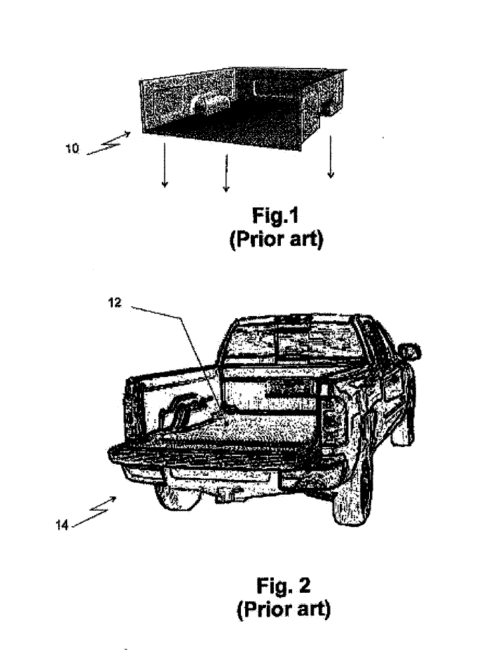

FIG. 1 shows a typical bedliner 10 formed of a plastics material and shaped and adapted to be fitted in intimate engagement in bed 12 of pick-up truck 14 of FIG. 2.

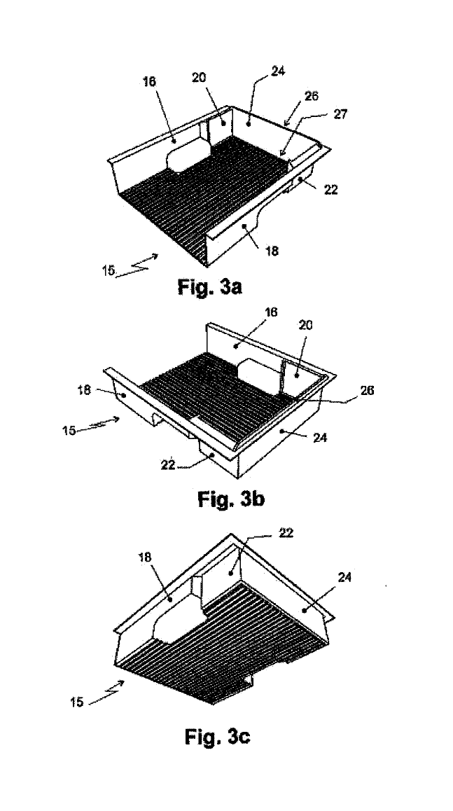

With reference to FIGS. 3a-3c, these show molded bedliner 15 having sides 16,18, with side portions 20,22 and an integral rectangular front panel 24 having a formed upper edge 26 and a lower edge 27, and suitably molded to be received by truck bed 12 and also to form sides of a container described hereinbelow.

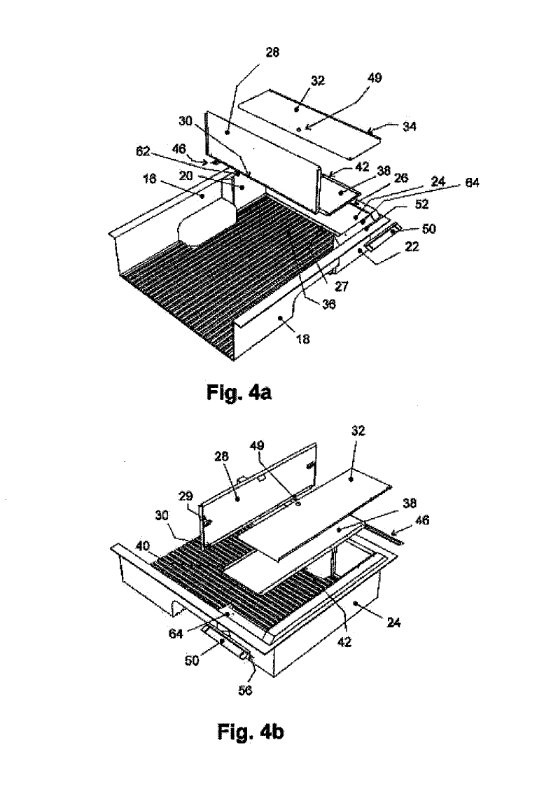

FIGS. 4a-4b show bedliner assembly having the bedliner shown in FIGS. 3a-3b and a rectangular forward panel 24 having a forward upper edge 26 and a lower edge 27;

a rectangular rear panel 28 retained between said vertical sides 16,18 and having a lower edge 30 hingedly mounted between said vertical sides 16,18 whereby said rear panel 28 is rotatable from a vertical mode to a collapsed mode;

a rectangular lid 32 having a front edge 34 hingedly connected adjacent to said forward upper edge 26 to allow said lid 32 to rotate from (i) a horizontal lid closed mode when engaged with said rear panel 28 when said rear panel 28 is in a vertical mode, to (ii) a vertical mode parallel to said forward panel 24;

and a bedliner floor 36. Rear panel 28 is releasably retained by a pair of bolts 29 to side portions 20,22 (only one side shown).

A base panel 38 has a rear edge 40 hingedly connected to lower edge 30 of rear panel 28, and a front edge 42 hingedly connected to lower edge 27 of front panel 24, whereby said base panel 38 is rotatable from a horizontal floor 36 abutment mode to a vertical mode parallel to said forward panel 24, and said rear panel 28 is rotatable from a vertical mode distal from said forward panel 24 to a vertical mode proximal to said forward panel 24.

In alternative embodiments, front edge 42 is hingedly connected to floor 36.

Thus, rear panel 28 is in a vertical mode and said lid 32 is in a horizontal mode in abutment with said rear panel as to constitute a closed container; and wherein

rear panel 28, said lid 32 and said forward panel 24 are in parallel alignment as to constitute a collapsed, folded container.

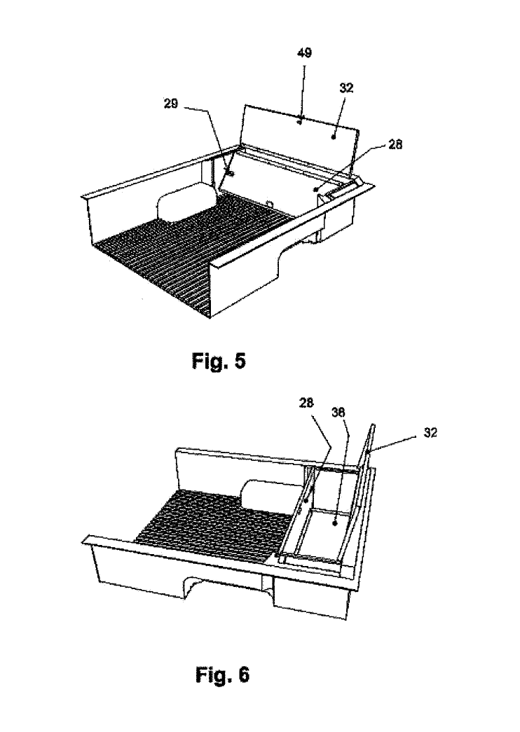

FIG. 5 shows the bedliner assembly in a partially collapsed mode while FIG. 6 shows, in part, the assembly having the panels constituting the container in an unfolded mode with an open lid 32.

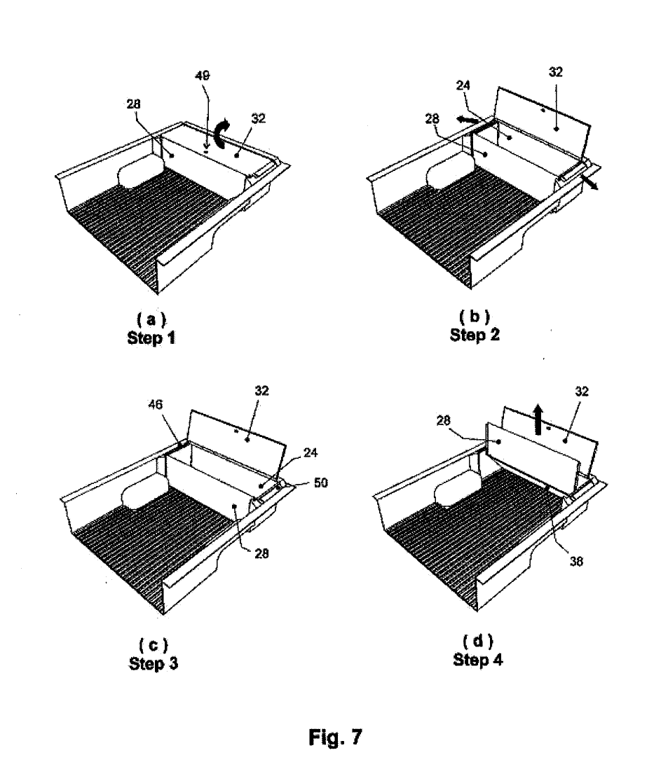

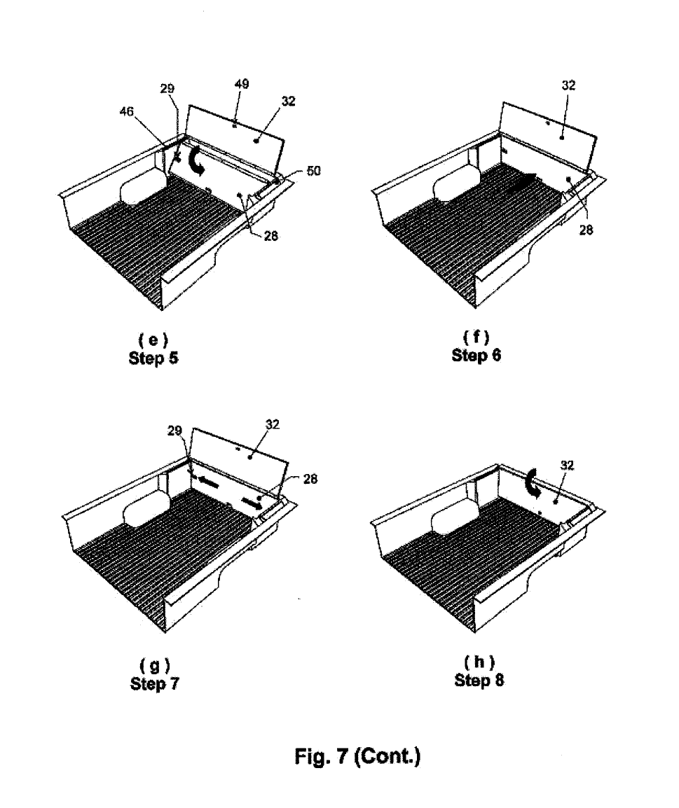

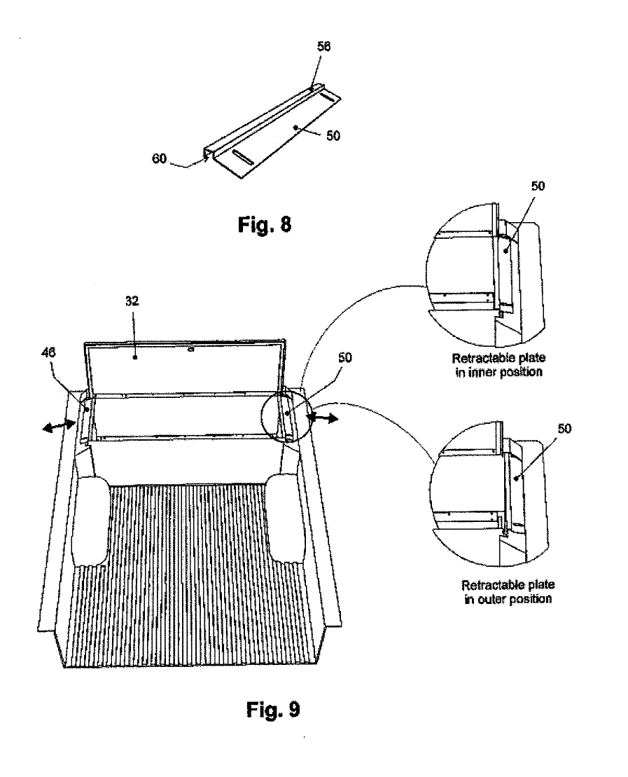

FIG. 7 represents a plurality of sketches showing the method by which the bedliner assembly is folded from a box-like container mode to a resultant collapsed and folded mode. The folding sequence is illustrated with reference to:-

Step 1 —shows bedliner with the container totally assembled in a closed mode.

Step 2 —unlock lock 49 and open lid 38 by rotating 90° .

Step 3 —slide retractable horizontal sliding plates 46 and 50 outwards to provide free unobstructed folding space for lid 38, rear panel 28 and base panel 38.

Step 4 —by sliding bolts 29, unclamp rear panel 28 from right side panel 18 and left side panel 16 and, by maintaining rear panel 28 vertically, rotate base panel 38 counter-clockwise about 45° .

Step 5 —rotate rear panel 28 clockwise about 135° .

Step 6 —while rotating rear panel 28 clockwise and base panel 38 counter-clockwise, push together until touching forward panel 24 and position both of them vertically.

Step 7 —use barrel bolts 29 to keep rear 28 and base panels 38 in place avoiding vibrations.

Step 8 —rotate lid 32 clockwise about 180° until vertical alignment with base panel 38 and rear panel 28.

FIGS. 8 and 9 shows a retractable elongate plate 46 for use affixed to side portion 22 of side 18, and a corresponding minor image plate 50 for use in affixed to side portion 20 of side 16 by fastening means, such as screws, rivets, bolts and the like (not shown).

Plates 46,50 have a pair of terminal lip portions 54,56 while operably allowing retraction of plates 46,50 inwardly and outwardly of the bedliner width in accordance with the direction of the arrows. Each of plates 46,50 has an inner terminal cavity 58,60, respectively, to embrace respective side portions of lid 32 when lid 32 closes the container. Thus, each plate 46,50 in an outwardly extended mode allows downward rotatable movement of lid 32 to form a close container, but restricts subsequent rotation of lid 32 when plates 46,50 are moved inwardly. The plates also restrict rotation of rear panel 28 and base panel 38.

In the embodiments shown, plates 46,50 are retained on inward flanges 62,64 affixed or integrally formed with side portions 20,22.

The designed bedliner-folding container in this embodiment according to the invention is a rectangular cuboid with six panels, three of them (forward panel 24, right panel 18 and left panel 16) are part of the bedliner, which has been molded for this purpose, and the other three, i.e. bottom panel 38, rear panel 28 and lid 32 are suitably hingedly connected as hereinabove described.

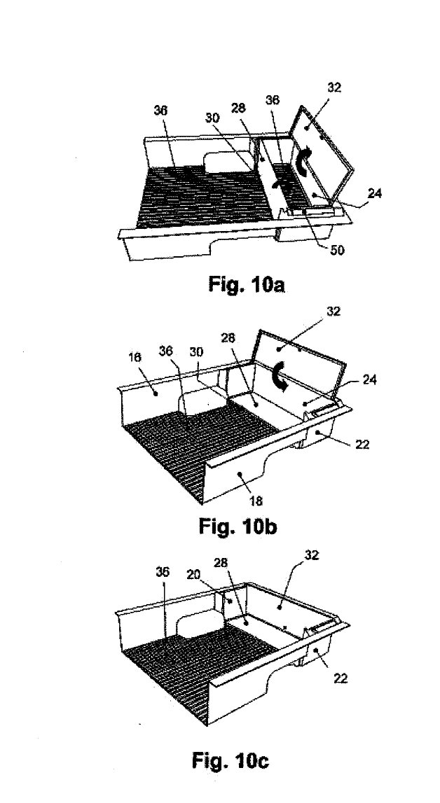

In an alternative embodiment, shown in FIGS. 10a-10c, there is no base panel 38, wherein lower edge 30 of rear 28 is hingedly mounted to bedliner floor 36. This allows of rotation of rear panel 28 from its vertical position when used with lid 32 to provide a closed container to a mode in horizontal, parallel alignment with floor 36, once lid 32 is unlocked and rotated to its mode in parallel alignment with forward panel 24.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A bedliner assembly shaped and adapted to be fitted within a pick-up truck hopper in intimate engagement, said bedliner assembly comprising
a pair of opposing rectangular planar vertical sides (16,18) spaced one from the other, one side (16) having a first side portion (20) and the other side (18) having an opposing second side portion (22);
a rectangular forward panel (24) having a forward upper edge (26) and a lower edge (27);
a rectangular rear panel (28) retained between said vertical sides (16,18) and having a lower edge (30) hingedly mounted between said vertical sides (16,18) whereby said rear panel (28) is rotatable from a vertical mode to a collapsed mode;
a rectangular lid (32) having a front edge (34) hingedly connected adjacent to said forward upper edge (26) to allow said lid (32) to rotate from (i) a horizontal lid closed mode when engaged with said rear panel (28) when said rear panel (28) is in a vertical mode, to (ii) a vertical mode parallel to said forward panel (24);
and a bedliner floor (36).

2. A bedliner assembly as claimed in claim 1 wherein said rear panel (28) is releasably retained to said vertical sides (16,18).

3. A bedliner assembly as claimed in claim 1 wherein said lower edge (30) is hingedly mounted to said floor (36).

4. A bedliner assembly as claimed in claim 1 comprising a rectangular base panel (38) between said portions (20,22) and having a rear edge (40) hingedly connected to said lower edge (30) of said rear panel (28), and a front edge (42) hingedly connected adjacent said forward panel (24) of said lower edge (27); whereby said base panel (38) is rotatable from a horizontal floor (36) abutment mode to a vertical mode parallel to said forward panel (24), and said rear panel (28) is rotatable from a vertical mode distal from said forward panel (24) to a vertical mode proximal to said forward panel (24).

5. A bedliner assembly as claimed in claim 4 wherein said front edge (42) is hingedly connected to said forward panel lower edge (27).

6. A bedliner assembly as claimed in claim 4 wherein said front edge (42) is hingedly connected to said floor (36).

7. A bedliner assembly as claimed in claim 1 wherein said rear panel (28) is in a vertical mode and said lid (32) is in a horizontal mode in abutment with said rear panel as to constitute a closed container.

8. A bedliner assembly as claimed in claim 1 wherein said rear panel (28), said lid (32) and said forward panel (24) are in parallel alignment as to constitute a collapsed, folded container.

9. A bedliner assembly as claimed in claim 8 wherein said rear panel (28), said lid (32), said base panel (38) and said forward panel (24) are in parallel alignment as to constitute a collapsed, folded container.

10. A bedliner assembly as claimed in claim 7 wherein said rear panel (24) is in a vertical mode, and said lid (32) and said base panel (38) are in a horizontal, parallel alignment as to constitute a closed container.

11. A bedliner assembly as claimed in claim 1 comprising
(a) a first retractable horizontal plate (46) affixed adjacent to the upper surface (48) of said first portion (20) operably retractable, (i) from an outer position to allow said rotatable movement of said lid (32) to, (ii) an inner position to restrict said rotatable movement of said lid (32); and
(b) a second retractable horizontal plate (50) affixed adjacent to the upper surface (52) of said second portion (22) operably retractable (i) from an outer position to allow said rotatable movement of said lid (32), (ii) to an inner position to restrict said rotatable movement of said lid (32).

12. A bedliner assembly as claimed in claim 11 wherein each of said retractable plates (46,50) has a longitudinal terminal lip portion (54,56) defining a lower channel (58,60) to receive and retain said lid (32) in a closed mode.

13. A bedliner assembly as claimed in claim 12 wherein each of said retractable plates (46,50) are retained to an inward flange (62,64) having said upper surface (48,52) of said first portion (20) and said second portion (22).

14. A bedliner assembly as claimed in claim 13 wherein said inward flanges (62,64) are integrally formed with said first and second side portions (20,22).
